(19) United States
(12) Patent Application Publication
(10) Pub. No.: US 2025/0164082 A1
(43) Pub. Date: May 22, 2025

(54) Qmin system for calculating latent gases in pressure reducing stations

(71) Applicant: AMIN JAMALPOUR, AHVAZ (IR)

(72) Inventor: AMIN JAMALPOUR, AHVAZ (IR)

(21) Appl. No.: 18/841,341

(22) PCT Filed: Feb. 22, 2023
(86) PCT No.: PCT/IB2023/051601

§ 371 Date: Aug. 23, 2024

(51) Int. Cl. F17D 5/00; F17D 3/01

(52) U.S. Cl. CPC F17D 5/005; F17D 3/01

(57) ABSTRACT

This invention relates to a system for measuring and calculating hidden gases, in which by adding a third line in a natural gas pressure reduction station, it becomes possible to determine consumption rates of Qmin and lower than Qmin capacity. This system leads to an increase in speed, a reduction in cross-sectional area and a reduction in pressure, and the consumption calculation is carried out when the main lines are in Qmin state. The said third line with a diameter of 2 inches includes a regulator (15), a shut off valve (21), a flow control device (11) or a ball valve (12), a counter (22), a venturi (14), and a safety valve (23).

### TECHNICAL FIELD

This invention is related to Fluid Mechanics.

### BACKGROUND ART

There is a pressure reduction station in the gas consumption line for large production factories and petrochemical and steel plants, power plants, sugarcane production complexes, which is responsible for controlling and reducing the pressure and measuring the volumetric flow rate of the consumed gas, this part has a vacuum. So that when the gas consumption decreases in certain seasons, the volumetric flow rate entering the factory is reduced and this value is lower than the defined value Qmin for the pressure reduction station.

This problem has caused the gas company to not be able to measure the volumetric flow rate for these seasons, and there will always be a gap of several billion cubic meters between the consumption and the gas that is delivered to the subscriber, which will cause the waste of several billion dollars of natural gas companies' capital.

In the previous years, this issue has been one of the problems that have always plagued the world's natural gas industry. The design and implementation of the bypass line device in pressure reduction and gas measurement stations in order to calculate uncounted gases and consumption lower than Qmin of subscribers and major industries of the natural gas company in the world has not been done. Therefore, with this system, the created challenge can be solved, and according to the investigations, patents similar to this work have not been registered so far, and if there is an existing patent, they have differences with this patent in terms of method and implementation.

### SUMMARY OF INVENTION

In low consumption seasons for companies and large consumers of natural gas all over the world, the calculation of volume flow rate lower than Qmin in pressure reduction stations is always not calculated correctly and causes high financial costs for natural gas companies all over the world. So that the flow of gas consumed in these factories is lower than the specified limit in the pressure reduction system, and practically the companies consume gas without paying for it.

By using the Qmin calculation system of hidden gases, which is designed based on Bernoulli's laws, in this design, the gas flow in the bypass line is measured by a turbine meter with a lower size, class and G-rate than the main lines. The pressure reduction operation in the gas pressure reduction stations is done by industrial regulators, and in this plan, the pressure is reduced from 250 psi to 62 psi by a 2 inch class 300 regulator in the new line (bypass line). Therefore, in pressurized stations, the amount of gas volumetric flows in low consumption seasons can be calculated for major subscribers and avoid the waste of financial costs for natural gas companies.

A clear and precise statement of the advantages of the invention are:
1—Calculation of values lower than the Qmin limit in pressure reduction stations
2—Reducing construction costs compared to older systems
3—No problems in the gas delivery system to customers
4—Preventing the waste of several billion cubic meters of natural gas
5—Preventing the waste of billions of dollars of capital of natural gas companies and the return of profit for large natural gas production companies around the world.

Bypass line design in major industry stations with Qmin problem is used to calculate the amount of gases consumed in low consumption seasons for large consumers. This invention is used in natural gas distribution companies all over the world for urban use, the work of large production warehouses, steel mills, and power plants to calculate hidden gases for large consumers.

### BRIEF DESCRIPTION OF DRAWINGS

FIG. 1 shows the components inside the system and the former system for measuring gas entering factories.

### DETAILED DESCRIPTION

lower than the Qmin capacity of turbine meters of pressure reduction and gas measurement stations of major industries, which has caused the amount of gas wastage or hidden gases to be unclear, so in this plan by increasing the speed and reducing the cross-sectional area and reducing the pressure by 2 psi and installing the industrial shut-off valve regulator on the third line or bypass compared to the consumption calculation when the main lines are in Qmin mode.

Among the advantages of this plan is determining the amount of gas wastage in major industries and calculating uncounted gases. According to the laws of Bernoulli's pressure changes, this is possible for the gas fluid, which increases the cross-sectional area and decreases the pressure up to 2 psi.

The smaller than the minimum volume should also be measured. For a more detailed review, we will explain the process according to the map file, which is as follows. By referring to the map file, it is shown that we have three lines with a fixed input pressure of 250 psi, which is reduced to output pressures through industrial regulators: P1: 57 psi line one—P2: 60 psi line two—P3: 63 psi line three.

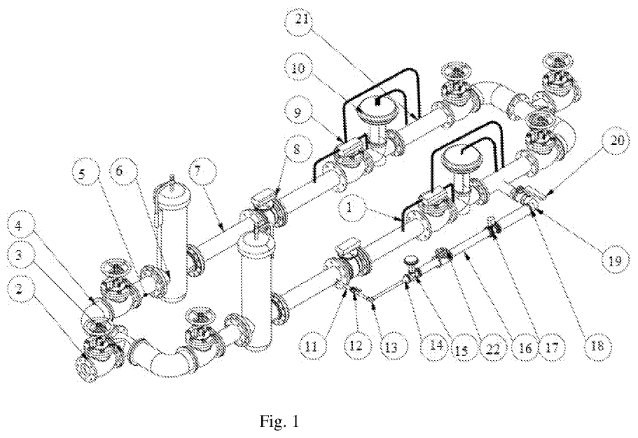

The line with the higher regulator pressure will always be in service. Therefore, normally the second line is in service. According to FIG. 1, the first line is higher and the second line is lower, and the third line has a smaller inch diameter according to the map. In this project, the third line was implemented with a size of 2 inches and on it the regulator (15), shot off valve (21). 65 and Qmin: 10 m\hat{ }3/h and Qmax: 100 m\hat{ }3/h were installed.

Considering that the turbine meter installed on line one and line two is 12 inch class 300 with G rate 4000 and Qmin: 320 m\hat{ }3/h and Qmax: 6400 m\hat{ }3/h. Now, in order to prevent the failure of mechanical equipment during the period when the gas station is suddenly put into service and the consumption is higher than Qmin, the 2-inch meter is found from a flow control device (11) or ball valve (12) in The entrance of the third line is used to transfer the additional load to the second line if the flow rate increases. In the third path, before the regulator (15), venturi (14) is installed, which according to Bernoulli's laws, the pressure value is reduced by 2 psi.

Then it goes to the regulator and after that it goes along the route shown in FIG. 1 and reaches the counter (22) and then to the safety valve (23), according to given the data, this meter calculates the minimum volume value. In fact, it calculates hidden gases. It should be mentioned that turbine meters are used in pressure reduction and gas measurement stations due to the high flow rate. In short, in this design, the gas flow in the bypass line is measured by a turbine meter with a lower size, class and G-rate than the main lines.

The pressure reduction operation in the gas pressure reduction stations is done by industrial regulators, and in this plan, the pressure is reduced from 250 psi to 62 psi by a 2 inch class 300 regulator in the new line (bypass line). The numbers and symbols given in this plan include: industrial regulator, industrial valves, dry filtration, turbine meter, related to pressure reduction stations used in industries, factories . . . natural gas industry.

1. A system for calculating Qmin of hidden gases in pressure reduction stations which is designed by using a series of connections and valves under pressure, comprising:
a safety valve,
a flow control device or a ball valve,
a shut off valve, a regulator, a venturi, and a counter that are installed in a third line and measures the flow rate of gases whose amount is less than the minimum limit.

2. A system according to claim 1, wherein in the third line, the fluid pressure is reduced by using the designed venturi and the pressure control system.

3. A system according to claim 2, wherein volumetric flow increases and the flow rate exceeds the flow limit Qmin.

4. A system according to claim 3, wherein hidden gases are calculated in pressure reduction stations.
